(19) United States
(12) Patent Application Publication
(10) Pub. No.: US 2013/0183895 A1
(43) Pub. Date: Jul. 18, 2013

(54) SYSTEM, APPARATUS, AND METHOD FOR FACILITATING MULTI-ANTENNA DIVERSITY FOR REPEATERS IN WIRELESS COMMUNICATION SYSTEMS

(71) Applicants: Dhananjay Ashok Gore, Bangalore (IN); Ravi Palanki, San Diego, CA (US)

(72) Inventors: Dhananjay Ashok Gore, Bangalore (IN); Ravi Palanki, San Diego, CA (US)

(73) Assignee: QUALCOMM Incorporated, San Diego, CA (US)

(21) Appl. No.: 13/435,730

(22) Filed: Mar. 30, 2012

Related U.S. Application Data
(60) Provisional application No. 61/586,571, filed on Jan. 13, 2012.

(51) Int. Cl. H04B 7/04; H04W 88/04

(52) U.S. Cl. CPC H04B 7/0404; H04W 88/04
USPC 455/7

(57) ABSTRACT

In accordance with aspects of the disclosure, a method, apparatus, and computer program product for wireless communication may include receiving a plurality of signals from a plurality of receiving donor antennas, delaying at least one of the received signals from at least one of the receiving donor antennas, combining the delayed signal with at least one of the other received signals from at least one other receiving donor antenna to generate a combined signal, amplifying the combined signal, and transmitting the amplified combined signal via a transmitting antenna.

### CLAIM OF PRIORITY UNDER 35 U.S.C. §119

This application claims the benefit of U.S. Provisional Patent Application No. 61/586,571, entitled “System, Apparatus, and Method for Facilitating Multi-Antenna Diversity for Repeaters in Wireless Communication Systems,” filed on Jan. 13, 2012, which is expressly incorporated herein by reference in its entirety.

### BACKGROUND

1. Field

The disclosure relates generally to communication systems, and more particularly, to systems, apparatuses, and methods for facilitating multi-antenna diversity for repeaters in wireless communications systems.

2. Background

Wireless communication systems are widely deployed to provide various telecommunication services, such as telephony, video, data, messaging, and broadcasts. Some conventional wireless communication systems may use multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, time division synchronous code division multiple access (TD-SCDMA) systems, and worldwide interoperability for microwave access (WiMAX).

For wireless communication systems, multiple-access technologies are utilized in various telecommunication standards to provide a common protocol that enables different wireless devices to communicate on a municipal, national, regional, and global level. These wireless multiple-access communication systems may simultaneously support communication for multiple wireless terminals. Each terminal communicates with one or more base stations via signal transmissions on a forward link and a reverse link. The forward link or downlink (DL) refers to a communication link from the base stations to the terminals, and the reverse link or uplink (UL) refers to a communication link from the terminals to the base stations. Communication links may be established via a single-in-single-out, multiple-in-signal-out, or a multiple-in-multiple-out (MIMO) system.

Generally, Universal Mobile Telecommunications System (UMTS) is a third-generation (3G) cell phone technology. UTRAN (UMTS Terrestrial Radio Access Network) is a term for referring to Node B and Radio Network Controllers (RNCs) in a UMTS radio access network that may carry many different traffic types from real-time Circuit Switched (CS) to Internet Protocol (IP) based Packet Switched (PS). UTRAN provides connectivity between a UE (User Equipment) and a core network. UTRAN comprises base stations, which may be referred to as Node B devices and/or RNC devices. The RNC devices provide control functionalities for one or more Node B devices. The Node B and the RNC may be the same device, although typical implementations have a separate RNC located in a central office serving multiple Node B devices. The RNC and its corresponding Node Bs may be referred to as the Radio Network Subsystem (RNS). There may be more than one RNS present in an UTRAN.

An example of an emerging telecommunication standard is Long Term Evolution (LTE). The LTE system is described in the Evolved UTRA (EUTRA) and Evolved UTRAN (EUTRAN) series of specifications. LTE provides a set of enhancements to the UMTS mobile standard promulgated by 3GPP. LTE is designed to better support mobile broadband Internet access by improving spectral efficiency, lower costs, improve services, make use of new spectrum, and better integrate with other open standards utilizing OFDMA on the downlink (DL), SC-FDMA on the uplink (UL), and multiple-input multiple-output (MIMO) antenna technology.

However, as the demand for mobile broadband access continues to increase, there exists a need for further improvements in LTE technology. Preferably, these improvements should be applicable to other multi-access technologies and the telecommunication standards that employ these technologies.

### SUMMARY

In accordance with aspects of the disclosure, an antenna-repeater interface apparatus for wireless communication comprises a first antenna input configured to receive signals from a first donor antenna of a repeater, a second antenna input configured to receive signals from a second donor antenna of the repeater, an adaptable delay in communication with the first antenna input, the adaptable delay configured to generate delayed signals from the first donor antenna, a combiner configured to generate a combined signal including the delayed signals from the first antenna input and the signals from the second antenna input, and an interface configured to provide an interface to amplifier circuitry of the repeater for amplifying the combined signal.

In accordance with aspects of the disclosure, a method for wireless communication comprises receiving signals from a first donor antenna of a repeater, receiving signals from a second donor antenna of the repeater, generating delayed signals from the first donor antenna, generating a combined signal including the delayed signals from the first antenna input and the signals from the second antenna input, and interfacing with amplifier circuitry of the repeater for amplifying the combined signal.

In accordance with aspects of the disclosure, an apparatus for wireless communication comprises means for receiving signals from a first donor antenna of a repeater, means for receiving signals from a second donor antenna of the repeater, means for generating delayed signals from the first donor antenna, means for generating a combined signal including the delayed signals from the first antenna input and the signals from the second antenna input, and means for interfacing with amplifier circuitry of the repeater for amplifying the combined signal.

In accordance with aspects of the disclosure, a computer program product comprises a computer-readable medium comprising codes executable to cause an apparatus to receive signals from a first donor antenna of a repeater, receive signals from a second donor antenna of the repeater, generate delayed signals from the first donor antenna, generate a combined signal including the delayed signals from the first antenna input and the signals from the second antenna input, and interface with amplifier circuitry of the repeater for amplifying the combined signal.

In accordance with aspects of the disclosure, a repeater apparatus for wireless communication comprises a frequency diversity circuit configured to receive a plurality of signals from a plurality of receiving donor antennas, delay at least one of the received signals from at least one of the receiving donor antennas, and combine the delayed signal with at least one of the other received signals from at least one other receiving donor antenna to generate a combined signal. The repeater apparatus further comprises an amplifier circuit configured to receive the combined signal from the frequency diversity circuit, amplify the combined signal, and transmit the amplified combined signal via a transmitting antenna.

In accordance with aspects of the disclosure, a method for wireless communication comprises receiving a plurality of signals from a plurality of receiving donor antennas, delaying at least one of the received signals from at least one of the receiving donor antennas, combining the delayed signal with at least one of the other received signals from at least one other receiving donor antenna to generate a combined signal, amplifying the combined signal, and transmitting the amplified combined signal via a transmitting antenna.

In accordance with aspects of the disclosure, an apparatus for wireless communication comprises means for receiving a plurality of signals from a plurality of receiving donor antennas, means for delaying at least one of the received signals from at least one of the receiving donor antennas, means for combining the delayed signal with at least one of the other received signals from at least one other receiving donor antenna to generate a combined signal, means for amplifying the combined signal, and means for transmitting the amplified combined signal via a transmitting antenna.

In accordance with aspects of the disclosure, a computer program product comprises a computer-readable medium comprising codes executable to cause an apparatus to receive a plurality of signals from a plurality of receiving donor antennas, delay at least one of the received signals from at least one of the receiving donor antennas, combine the delayed signal with at least one of the other received signals from at least one other receiving donor antenna to generate a combined signal, amplify the combined signal, and transmit the amplified combined signal via a transmitting antenna.

### BRIEF DESCRIPTION OF THE DRAWINGS

FIG. 1A shows a diagram illustrating an embodiment of a network architecture, in accordance with aspects of the disclosure.

FIG. 1B shows a diagram illustrating an embodiment of a wireless communication system, in accordance with aspects of the disclosure.

FIGS. 2A and 2B show diagrams illustrating environments for a repeater, in accordance with aspects of the disclosure.

FIGS. 3A and 3B show diagrams illustrating apparatuses comprising an antenna-repeater interface, in accordance with aspects of the disclosure.

FIG. 4 shows a diagram illustrating a hardware implementation of an apparatus comprising a repeater for a wireless communication system, in accordance with aspects of the disclosure.

FIG. 5 shows a diagram illustrating an embodiment of a hardware implementation for an apparatus employing a processing system, in accordance with aspects of the disclosure.

FIG. 6 shows a flow diagram illustrating a methodology for wireless communication, in accordance with aspects of the disclosure.

FIG. 7 shows a diagram illustrating the functionality of an apparatus, in accordance with aspects of the disclosure.

FIG. 8 shows a flow diagram illustrating another methodology for wireless communication, in accordance with aspects of the disclosure.

FIG. 9 shows a diagram illustrating the functionality of another apparatus, in accordance with aspects of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in diagram form to avoid obscuring such concepts.

Several aspects of telecommunication systems are presented herein with reference to various apparatus and methods. These apparatus and methods are described in the following detailed description and illustrated in the accompanying drawings by various blocks, modules, components, circuits, steps, processes, algorithms, etc. (collectively referred to as “elements”). These elements may be implemented utilizing electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. “Computer-readable medium” does not refer to transitory propagating signals and may be referred to as a non-transitory computer-readable medium, which refers to computer readable media that are manufactures. A non-transitory computer-readable medium include, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer and that is a manufacture. In accordance with aspects of the disclosure, the computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

The techniques described herein may be utilized for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often utilized interchangeably. A CDMA network may implement a radio technology such as Universal Terrestrial Radio Access (UTRA), CDMA2000, etc. UTRA includes Wideband-CDMA (W-CDMA) and Low Chip Rate (LCR). CDMA2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). Long Term Evolution (LTE) is an upcoming release of UMTS that uses E-UTRA. UTRA, E-UTRA, GSM, UMTS, and LTE are described in documents from an organization named “3rd Generation Partnership Project” (3GPP). CDMA2000 is described in documents from an organization named “3rd Generation Partnership Project 2” (3GPP2). These various radio technologies and standards are known in the art. For clarity, certain aspects of the techniques are described below for LTE, and LTE terminology is utilized in much of the description below.

In accordance with aspects of the disclosure, single carrier frequency division multiple access (SC-FDMA) is a technique utilizing single carrier modulation and frequency domain equalization. SC-FDMA has similar performance and essentially the same overall complexity as those of OFDMA system. SC-FDMA signal has lower peak-to-average power ratio (PAPR) because of its inherent single carrier structure. SC-FDMA has drawn great attention, especially in the uplink communications where lower PAPR greatly benefits the mobile terminal in terms of transmit power efficiency. It is currently a working assumption for uplink multiple access scheme in 3GPP Long Term Evolution (LTE), or Evolved UTRA.

In accordance with aspects of the disclosure, a wireless multiple-access communication system is configured to simultaneously support communication for multiple wireless terminals. Each terminal communicates with one or more base stations via transmissions on the forward and reverse links. The forward link or downlink (DL) refers to the communication link from the base stations to the terminals, and the reverse link or uplink (UL) refers to the communication link from the terminals to the base stations. This communication link may be established via a single-in-single-out system, a multiple-in-single-out system, or a multiple-in-multiple-out (MIMO) system.

In accordance with aspects of the disclosure, a MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}≦min{N_{T}, N_{R}}. Each of the N_{S} independent channels corresponds to a dimension. The MIMO system may provide improved performance (e.g., higher throughput and/or greater reliability) if the additional dimensionalities created by the multiple transmit and receive antennas are utilized.

In accordance with aspects of the disclosure, a MIMO system supports a time division duplex (TDD) and frequency division duplex (FDD) systems. For instance, in a TDD system, the forward and reverse link transmissions are on the same frequency region so that the reciprocity principle allows the estimation of the forward link channel from the reverse link channel. This enables the access point to extract transmit beamforming gain on the forward link when multiple antennas are available at the access point.

Various aspects of the disclosure are described herein in connection with a mobile device. In some aspects, the mobile device may also be referred to as a system, a subscriber unit, a subscriber station, mobile station, mobile, mobile device, cellular device, multi-mode device, remote station, remote terminal, access terminal, user terminal, user agent, a user device, or user equipment, or the like. A subscriber station may be a cellular telephone, a cordless telephone, a Session Initiation Protocol (SIP) phone, a wireless local loop (WLL) station, a personal digital assistant (PDA), a handheld device having wireless connection capability, or other processing device connected to a wireless modem or similar mechanism facilitating wireless communication with a processing device.

Various aspects of the disclosure are described with reference to the drawings. In the following description, for purposes of explanation, numerous specific details are set forth to provide a thorough understanding of one or more aspects. It may be evident, however, that the various aspects may be practiced without these specific details. In other instances, well-known structures and devices are shown in diagram form to facilitate describing these aspects.

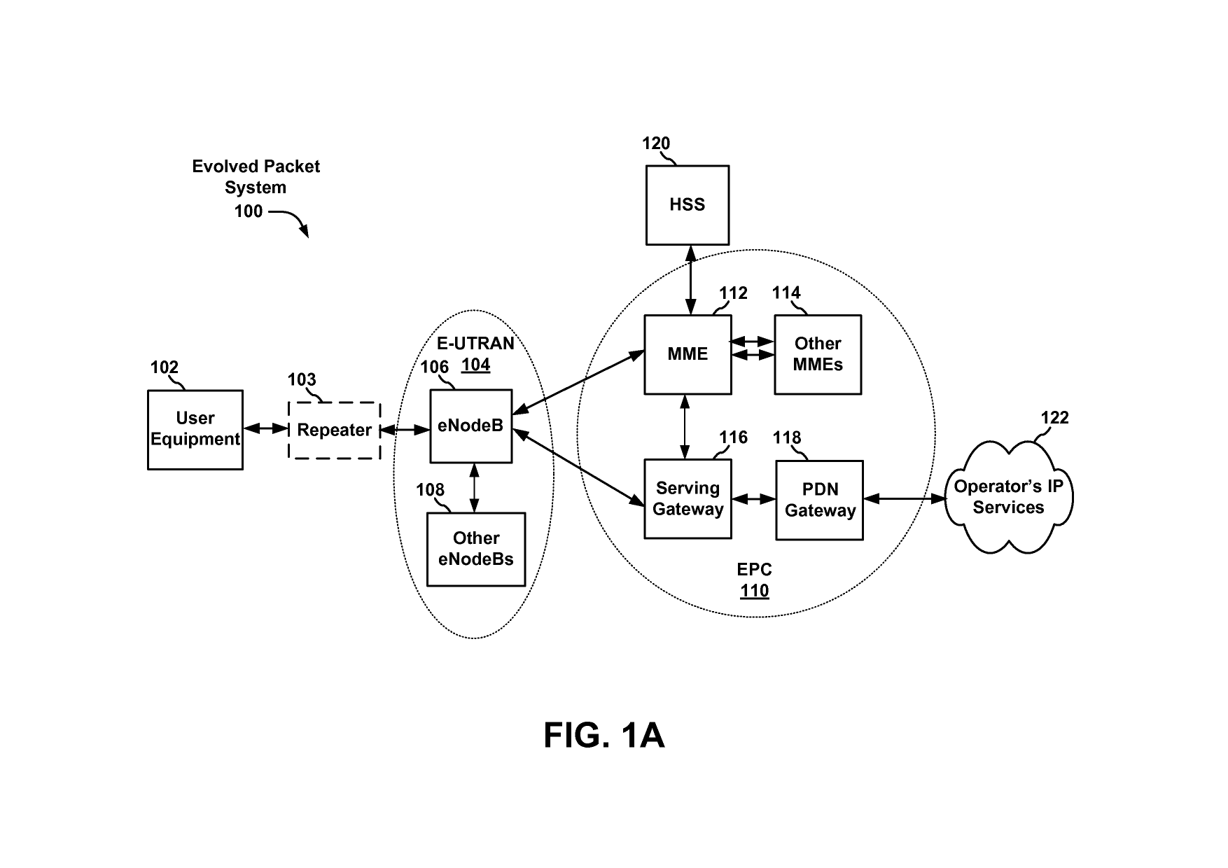

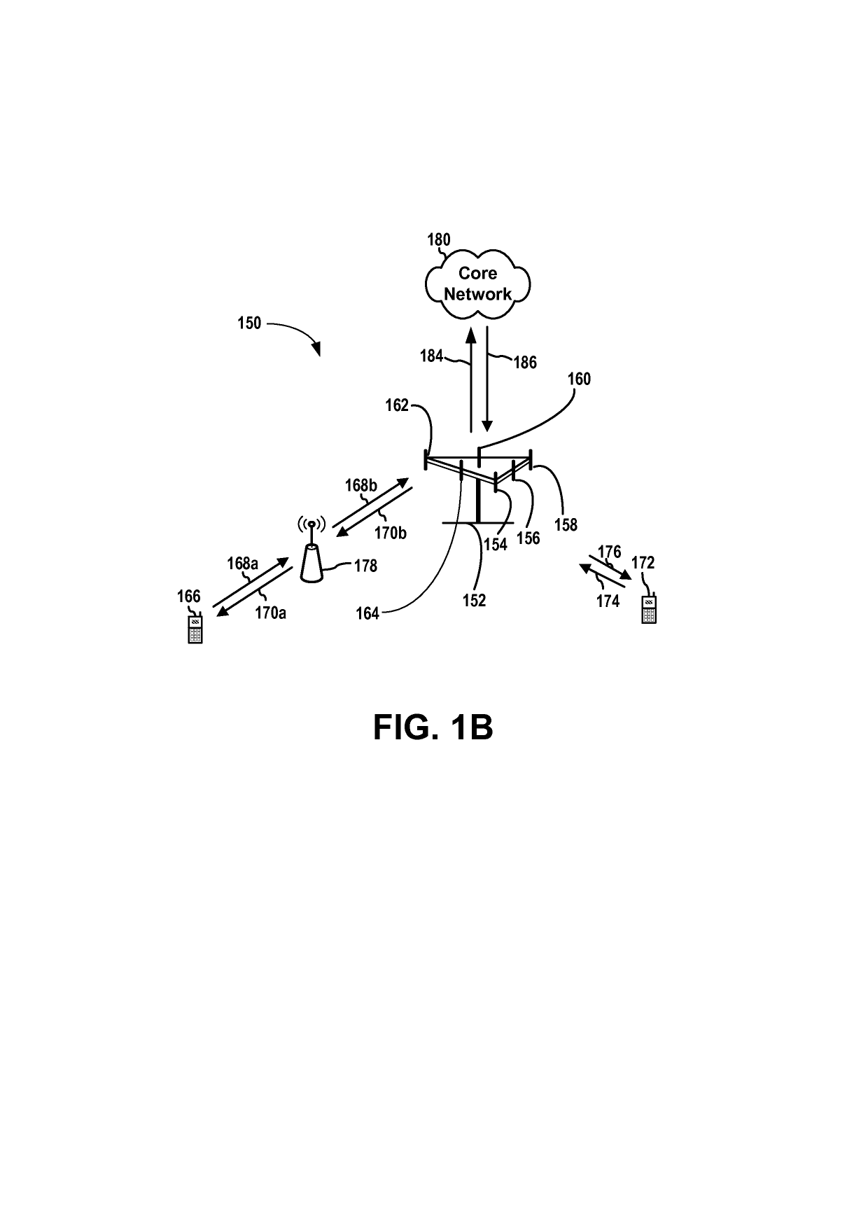

FIG. 1A shows a diagram illustrating a network architecture 100 employing various apparatuses, in accordance with aspects of the disclosure. In an implementation, the network architecture 100 may comprise an LTE network architecture and may be referred to as an Evolved Packet System (EPS) 100. The EPS 100 comprises one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's IP Services 122. The EPS 100 may be configured to interconnect with other access networks, but for simplicity those entities/interfaces are not shown. Referring to FIG. 1A, the EPS is configured to provide packet-switched (PS) services. However, as those skilled in the art will readily appreciate, the various concepts presented throughout this disclosure may be extended to networks providing circuit-switched (CS) services.

In an implementation, the EPS 100 may include a repeater 103 to achieve coverage extension. The use of one or more repeaters, such as the repeater 103, may increase in the context of personal or residential coverage extension. In an example, the repeater 103 may comprise a physical layer device, operable to amplify received signals, including usable signals as well as noise and interference, as the repeater 103 may not decode data. The repeater 103 state may not be communicated to either the eNodeB 106 of the E-UTRAN 104 or the UE 102. In one operational implementation, where the repeater 103 is at its maximum output power but the UE 102 output power is not at a maximum, then any UE 102 power increases may result in saturating the repeater 103. In another operational implementation, a repeated signal received at the E-UTRAN 104 may not be decodable and may cause the E-UTRAN 104 to request the UE 102 to raise its power.

In an aspect of the disclosure, the repeater 103 may comprise a single element for a donor antenna and a single element for a coverage antenna. In another aspect of the disclosure, the repeater 103 comprises multiple elements for a plurality of donor antennas to implement at least dual antenna diversity, wherein multi-receive-antenna diversity may be provided by increasing the number of donor antennas while maintaining a single element for a coverage antenna. As will be described herein, configurations of the disclosure reduce the cost of multiple front ends (including, for example, low noise amplifiers (LNAs), down convertors, etc.) by enabling dual (or multi-antenna) diversity with only a single front end chain. Therefore, aspects of the disclosure are adapted to retain the diversity available via multiple antenna elements without requiring each antenna element to have its own accompanying LNA and down convertor chain.

In some implementations, repeater performance may be bounded by or dependent on one or more parameters, such as, for example, a maximum amplification (gain) and a maximum output power. The repeater may be operable to use dynamic gain control and may adjust signal amplification to maximize gain given the above parametric constraints. Determining an amplification factor may take time and thus may be based on received power before the time the amplification is applied, and the gain may be adapted to control self-interference impacts.

In an implementation, the E-UTRAN 104 includes the evolved Node B (eNodeB) 106 and other eNodeBs 108. The eNodeB 106 provides user and control plane protocol terminations toward the UE 102. The eNodeB 106 may be connected to the other eNodeBs 108 via an X2 interface (i.e., backhaul). The eNodeB 106 may also be referred to as a base station, a base transceiver station, a radio base station, a radio transceiver, a transceiver function, a basic service set (BSS), an extended service set (ESS), or some other suitable terminology. The eNodeB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The UE 102 may also be referred to as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring to FIG. 1A, the eNodeB 106 is connected by an 51 interface to the EPC 110. The EPC 110 includes a Mobility Management Entity (MME) 112, other MMEs 114, a Serving Gateway 116, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 include the Internet, the Intranet, an IP Multimedia Subsystem (IMS), and a PS Streaming Service (PSS).

FIG. 1B shows a diagram illustrating an embodiment of a wireless communication system 150, in accordance with aspects of the disclosure. In an implementation, the wireless communication system 150 comprises a multiple access wireless communication system. The wireless communication system 150 may comprise one or more UE devices 166, 172, at least one repeater (R) device 178, at least one base station device (BS) 152, and at least one core network (CN) 180.

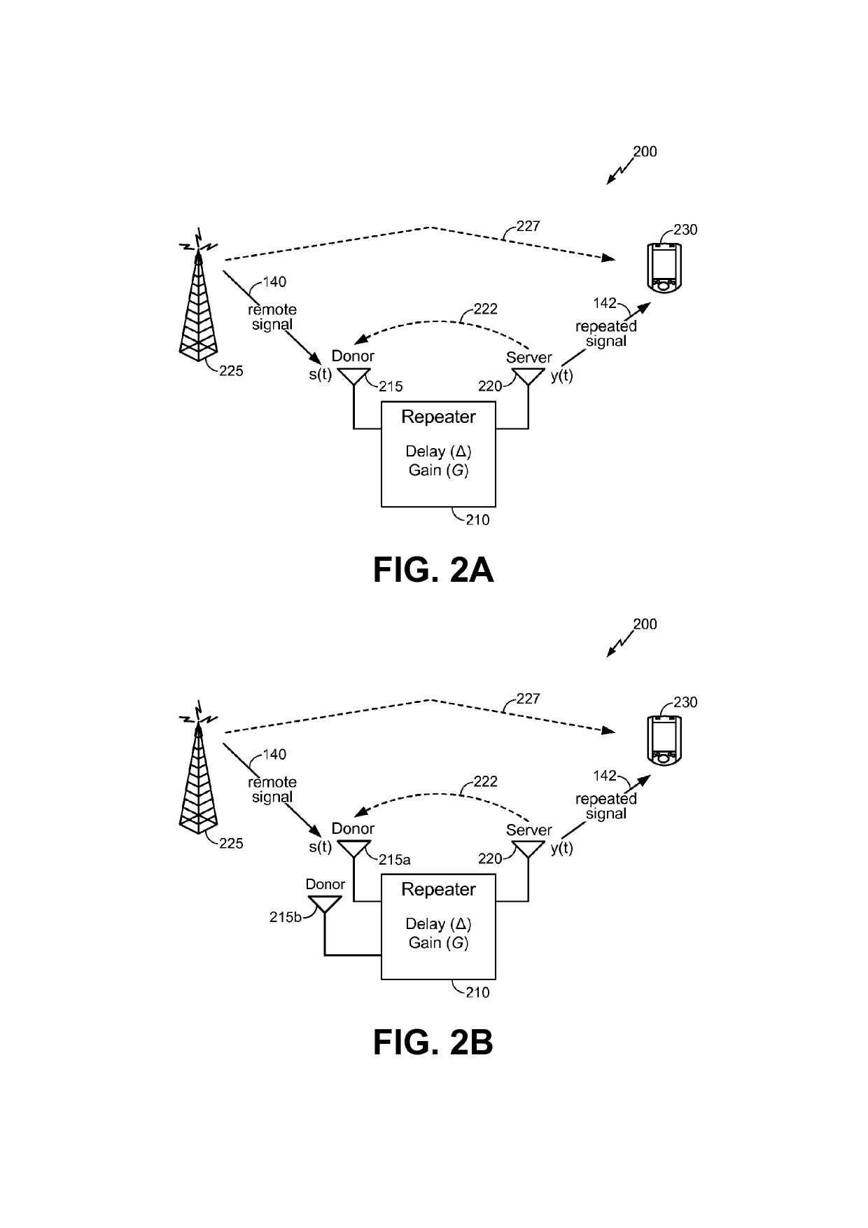

The BS 152 comprises, in an implementation, an access point (AP) comprising multiple antenna groups, for example, one antenna group including antennas 154, 156, another antenna group including antennas 158, 160, and another antenna group including antennas 162, 164. Referring to FIG. 2A, even though two antennas are shown for each antenna group, more or fewer antennas may be utilized for each antenna group without departing from the scope of the disclosure.

The UE 166 comprises, in an implementation, an access terminal (AT) that is in communication with any one of the antennas 162, 164, wherein at least one of the antennas 162, 164 transmit information to the access terminal 166 over forward link or downlink (DL) 170a, 170b via the repeater 178 and receive information from the UE 166 over reverse link or uplink (UL) 168a, 168b via the repeater 178.

The UE 172 comprises, in an implementation, an access terminal (AT) in communication with any one of the antennas 156, 158, wherein at least one of the antennas 156, 158 transmit information to the UE 172 over forward link or DL 176 and receive information from the UE 172 over reverse link or uplink (UL) 174.

The repeater 178 comprises, in an implementation, a communication device configured to receive one or more signals, amplify the received signals, and transmit the amplified signals in a manner consistent with the functionality of a repeater having multi-receive-antenna diversity. As described herein, multi-receive-antenna diversity may be provided by increasing the number of donor antennas to enable at least dual (or multi-antenna) diversity at low cost by retaining the diversity available with multiple antenna elements without requiring each antenna element to have its own accompanying front end chain (e.g., LNAs, down convertors, etc). Further scope related to these aspects of the disclosure are described in greater detail herein.

In an aspect of the disclosure, in a frequency division duplexing (FDD) system, communication links 168a, 168b, 170a, 170b, 174, and 176 may utilize different frequencies for communication. For instance, DL 170a, 170b may utilize a different frequency then that utilized by UL 168a, 168b.

In an aspect of the disclosure, each antenna group and/or the area in which they are configured to communicate may be referred to as a sector of the base station. In an example, each antenna group may be configured to communicate with any UE that is within a sector of the areas covered by the base station.

When communicating over forward links or DLs 170a, 170b, 176, the transmitting antennas of the BS 152 may utilize beamforming to improve a signal-to-noise ratio (SNR) of the forward links or DLs 170a, 170b, 176 for the different UEs 166, 174, respectively. For instance, a base station, such as the BS 152, utilizing beamforming to transmit to UEs, such as UEs 166, 172, scattered randomly throughout its coverage may cause less interference to the UEs in neighboring cells than a base station transmitting through a single antenna to all its UEs.

In various implementations, a base station may be a fixed station used for communicating with UE and may be referred to as an access point (AP), a Node B (NB), evolved Node B (eNodeB or eNB), or some other terminology. A UE may be referred to as an access terminal (AT), a wireless communication device, terminal, or some other terminology. Moreover, a base station may be a macrocell access point, femtocell access point, picocell access point, and/or the like. The repeater may be configured as a base station or user equipment.

In various embodiments, as described herein, one or more segments or one or more extension carriers may be linked to a regular carrier resulting in a composite bandwidth over which the user equipment may transmit information to and/or receive information from the base station.

In an aspect of the disclosure, the base station 152 is configured to communicate with the core network (CN) 180 via one or more communication paths, such as, for example, an uplink (UL) 184 and/or a downlink (DL) 186. The CN 180 may comprise part of a communication network that provides various services to users connected by the wireless communication system 150. The CN 180 may refer to communication facilities that provide various paths for exchange of information between various sub-networks via a mesh topology. The CN 180 may be referred to as a backbone network. The various concepts presented throughout this disclosure may be implemented across a broad variety of telecommunication systems, network architectures, and communication standards.

FIGS. 2A and 2B show diagrams illustrating environments for a repeater, in accordance with aspects of the disclosure. In particular, FIG. 2A shows a diagram illustrating an environment 200 for a repeater 210 having a single donor antenna 215, and FIG. 2B shows a diagram illustrating the environment 200 for the repeater 210 having a plurality of donor antennas 215a, 215b to provide at least dual receive antenna diversity by increasing the number of donor antenna elements.

FIG. 2A shows a diagram illustrating an environment 200 for a repeater 210 having forward link or downlink (DL) transmissions; i.e., a remote signal 140 from a base station 225 (e.g., Node B (NB) or evolved Node B (eNB)) is intended for a mobile device 230 (e.g., User Equipment (UE)), in accordance with aspects of the disclosure. The repeater 210 may be utilized in environment 200 if an unrepeated signal along a path 227 between the base station 225 and the mobile device 230 may not provide sufficient signal strength for effective voice and/or data communications received at the mobile device 230.

In an aspect of the disclosure, the repeater 210 with a gain (G) and a delay (A) may be configured to repeat the remote signal 140 received from the base station 225 on at least one donor antenna 215 to the mobile device 230 using a server antenna 220. The repeater 210 includes forward link or downlink (DL) circuitry for amplifying and transmitting signals received from the base station 225 to the mobile device 230 through the donor antenna 215 and the server antenna 220. The repeater 210 may also include reverse link or uplink (UL) circuitry for amplifying and transmitting signals from the mobile device 230 to the base station 225. At the repeater 210, the remote signal s(t) 140 is received as an input signal, and the remote signal s(t) 140 is repeated as a repeated or amplified signal y(t) 142. In accordance with aspects of the disclosure, the repeater 210 may comprise one or more donor antennas 215 including a plurality of donor antennas 215 without departing from the scope of the disclosure.

As described in greater detail herein, aspects of the disclosure provide LTE systems with multi-antenna diversity by, for example, increasing the number of donor antennas, as shown, for example, in FIG. 2B. To reduce the added cost of multiple front ends (e.g., LNAs, down convertors, etc), aspects of the disclosure are adapted to retain the diversity available with multiple antenna elements without requiring each antenna element to have its own accompanying LNA and down convertor chain, which is described in greater detail herein.

In an aspect of the disclosure, the gain (G) of the repeater 210 may be limited by the isolation between the at least one donor antenna 215 and the server antenna 220. If the gain (G) is significantly large, the repeater 210 may become unstable due to signal leakage, which refers to a phenomenon when a portion of the signal that is transmitted from one antenna (e.g., the server antenna 220) is received by the other antenna (e.g., the at least one donor antenna 215), as shown by a feedback path 222. Without interference cancellation, the repeater 210 may amplify a feedback signal (i.e., leakage signal) as part of normal operation, and the amplified feedback signal may be transmitted by the server antenna 220. The repeated transmission of the amplified feedback signal due to signal leakage and high repeater gain may lead to repeater instability.

For instance, in an implementation, assume that a channel to the donor antenna is h1. The donor antenna may receive a downlink (DL) signal over this antenna, amplify the DL signal, and transmit the DL signal via a coverage antenna. If h1 has single order diversity (e.g., flat fading or PedA channel), then the user equipment (UE) experiences single diversity order.

In another instance, assume two antenna elements at the donor antenna that are combined in RF (combiner). Let h1 and h2 be the channels to the two antenna elements, respectively. Then, the composite channel to the donor antenna is h1+h2. The donor antenna receives the DL signal, amplifies the DL signal, and transmits the DL signal via the coverage antenna. If h1 and h2 have single order diversity, then UE still experiences single order diversity.

In still another instance, assume that the two antenna elements are combined after a delay is introduced in the first antenna element. Then, the composite channel to the donor antenna is h1+h2(D̂N), where N is the number of samples corresponding to the adaptive delay. The donor antenna receives the DL signal, amplifies the DL signal, and transmits the DL signal via the coverage antenna. If h1 and h2 have single order diversity, the composite channel has dual diversity (frequency diversity). Accordingly, assuming proper channel coding, the diversity order may be the same as that available through two antennas with accompanying independent RF chains.

In an aspect of the disclosure, an adaptive delay should be large enough that the paths (h1 and h2) are resolvable, but not too large that the adaptive delay violates the cyclic prefix and causes performance degradation. As such, a few samples delay (e.g., LTE sampling) may be sufficient.

Therefore, aspects of the disclosure enable dual (or more) diversity with multiple antenna elements and retain a single receive chain, which lowers cost by only having a single receive chain. In some embodiments, existing repeater systems may be retro-fitted with antenna elements combined properly as described herein to meet LTE dual diversity requirements.

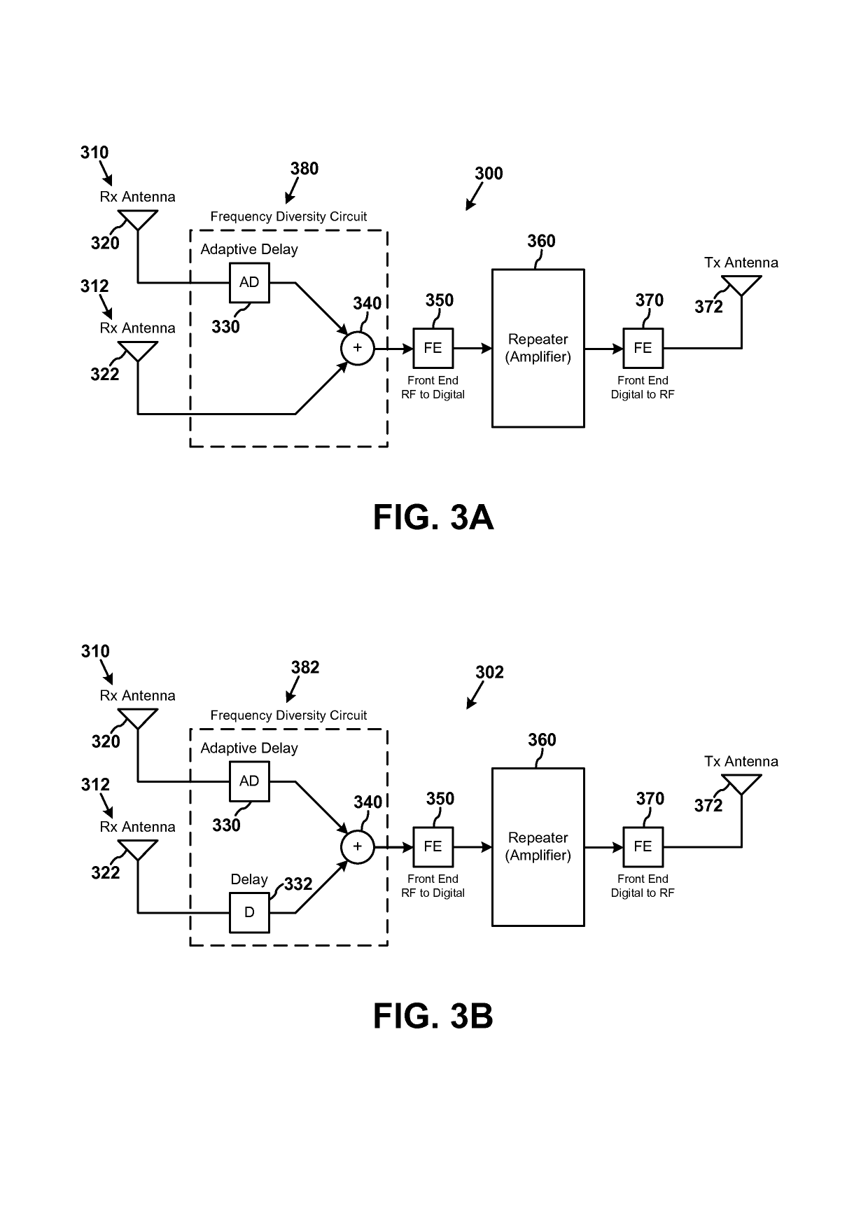

FIG. 3A shows a diagram illustrating an apparatus 300 comprising an antenna-repeater interface, in accordance with an aspect of the disclosure. In various embodiments, the apparatus 300 may be implemented as a repeater or part thereof.

In an implementation, the apparatus 300 comprises a plurality of antenna inputs including, for example, a first antenna input 310 configured to receive signals from a first receiving donor antenna (Rx Antenna) 320 and a second antenna input 312 configured to receive signals from a second receiving donor antenna (Rx Antenna) 322.

The apparatus 300 comprises an adaptable delay (Adaptive Delay) 330 in communication with the first antenna input 310, wherein the adaptable delay (Adaptive Delay) 330 is configured to generate delayed signals from the first receiving donor antenna (Rx Antenna) 320.

The apparatus 300 comprises a combiner (+) 340 configured to generate a combined signal including the delayed signals from the first antenna input 310 and the signals from the second antenna input 312.

The apparatus 300 comprises an interface (e.g., front end RF to digital circuitry) 350 configured to provide interfacing to repeater-amplifier circuitry 360 of the apparatus 300, such as a repeater.

The apparatus 300 comprises another interface (e.g., front end digital to RF circuitry) 370 configured to provide interfacing from the repeater-amplifier circuitry 360 to a transmission antenna (Tx Antenna) 372.

In an implementation, referring to FIG. 3A, a frequency diversity circuit 380 may be defined as comprising at least the adaptable delay (Adaptive Delay) 330 and the combiner (+) 340.

Accordingly, aspects of the disclosure provide an apparatus (e.g., an antenna-repeater interface apparatus 300) comprising a first antenna input (e.g., 310) configured to receive signals from a first donor antenna (e.g., 320) of a repeater and a second antenna input (e.g., 312) configured to receive signals from a second donor antenna (e.g., 322) of the repeater. The apparatus (e.g., 300) may comprise an adaptable delay (e.g., 330) in communication with the first antenna input (e.g., 310), wherein the adaptable delay (e.g., 330) is configured to generate delayed signals from the first donor antenna (e.g., 320). The apparatus (e.g., 300) may comprise a combiner (e.g., 340) configured to generate a combined signal including the delayed signals from the first antenna input (e.g., 310) and the signals from the second antenna input (e.g., 312). The apparatus (e.g., 300) may comprise an interface (e.g., 350) configured to provide an interface to amplifier circuitry (e.g., 360) of the repeater.

FIG. 3B shows a diagram illustrating another apparatus 302 comprising another antenna-repeater interface, in accordance with another embodiment of the disclosure. In various embodiments, the apparatus 302 may be implemented as a repeater or part thereof.

The apparatus 302 comprises the first antenna input 310 configured to receive signals from the first receiving donor antenna (Rx Antenna) 320 and the second antenna input 312 configured to receive signals from the second receiving donor antenna (Rx Antenna) 322.

The apparatus 302 comprises the adaptable delay (Adaptive Delay) 330 in communication with the first antenna input 310, wherein the adaptable delay (Adaptive Delay) 330 is configured to generate delayed signals from the first receiving donor antenna (Rx Antenna) 320.

The apparatus 302 comprises a delay (Delay) 332 in communication with the second antenna input 312, wherein the delay (Delay) 332 is configured to generate delayed signals from the second receiving donor antenna (Rx Antenna) 322.

The apparatus 302 comprises the combiner (+) 340 configured to generate a combined signal including the delayed signals from the first antenna input 310 and the delayed signals from the second antenna input 312.

The apparatus 300 comprises the interface (e.g., front end RF to digital circuitry) 350 configured to provide interfacing to repeater-amplifier circuitry 360 of the apparatus 302, such as a repeater.

The apparatus 300 comprises another interface (e.g., front end digital to RF circuitry) 370 configured to provide interfacing from the repeater-amplifier circuitry 360 to the transmission antenna (Tx Antenna) 372.

In an implementation, another frequency diversity circuit 382 may be defined as comprising at least the adaptable delay (Adaptive Delay) 330, the delay (Delay) 332, and the combiner (+) 340. The frequency diversity circuit 382 may be configured to separately delay each of the received signals from each of the receiving donor antennas 320, 322, respectively, with a sampling delay difference and combine the delayed signals to generate a combined signal.

It should be appreciated that aspects of the disclosure are configured to enable dual diversity with multiple receiving antenna elements without requiring each receiving antenna elements to have its own accompanying front end LNA and down convertor chain. In various embodiments, the multiple receiving antenna elements are receiving donor antenna elements of a repeater.

Accordingly, aspects of the disclosure provide an apparatus (e.g., 300, 302) comprising a frequency diversity circuit (e.g., 380, 382) configured to receive a plurality of signals from a plurality of receiving donor antennas (e.g., 320, 322), delay at least one of the received signals from at least one of the receiving donor antennas (e.g., 320), and combine the delayed signal with at least one of the other received signals from at least one other receiving donor antenna (e.g., 322) to generate a combined signal (e.g., via the combiner 340). The apparatus (e.g., 300, 302) may comprise an amplifier circuit (e.g., 360) configured to receive the combined signal from the frequency diversity circuit (e.g., 380, 382), amplify the combined signal, and transmit the amplified combined signal via a transmitting antenna (e.g., 372).

In an implementation, referring to FIG. 3A, the frequency diversity circuit 380 may comprise at least the adaptable delay 330 and the combiner 340. The frequency diversity circuit 380 may comprise the adaptable delay 330 configured to delay at least one of the received signals from at least one of the receiving donor antennas (e.g., 320) by one or more samples to generate the delayed signal. The frequency diversity circuit 380 may comprise the combiner 340 configured to combine the delayed signal to at least one of the other received signals from at least one other receiving donor antenna (e.g., 322) to generate the combined signal. The combiner 340 may comprise an adder or adding circuitry configured to combine or add the delayed signal to the at least one of the other received signals from the at least one other receiving donor antenna to generate the combined signal. As shown in FIG. 3A, the apparatus 300 may comprise a single receive chain (e.g., front end RF to digital circuitry 350) interposed between the frequency diversity circuit 380 and the repeater-amplifier circuit 360 and a single transmit chain (e.g., front end digital to RF circuitry 370) interposed between the repeater-amplifier circuit 360 and a transmitting antenna (e.g., 372).

In another implementation, referring to FIG. 3B, the frequency diversity circuit 382 may be configured to separately delay each of the received signals from each the receiving donor antennas (e.g., 320, 322) with a sampling delay difference and combine the delayed signals to generate a combined signal.

Accordingly, aspects of the disclosure enable multi-antenna diversity with multiple antenna elements while retaining a single receive chain. Some existing repeater systems may be retro-fitted with antenna elements combined in a manner as provided herein to meet LTE dual diversity requirements.

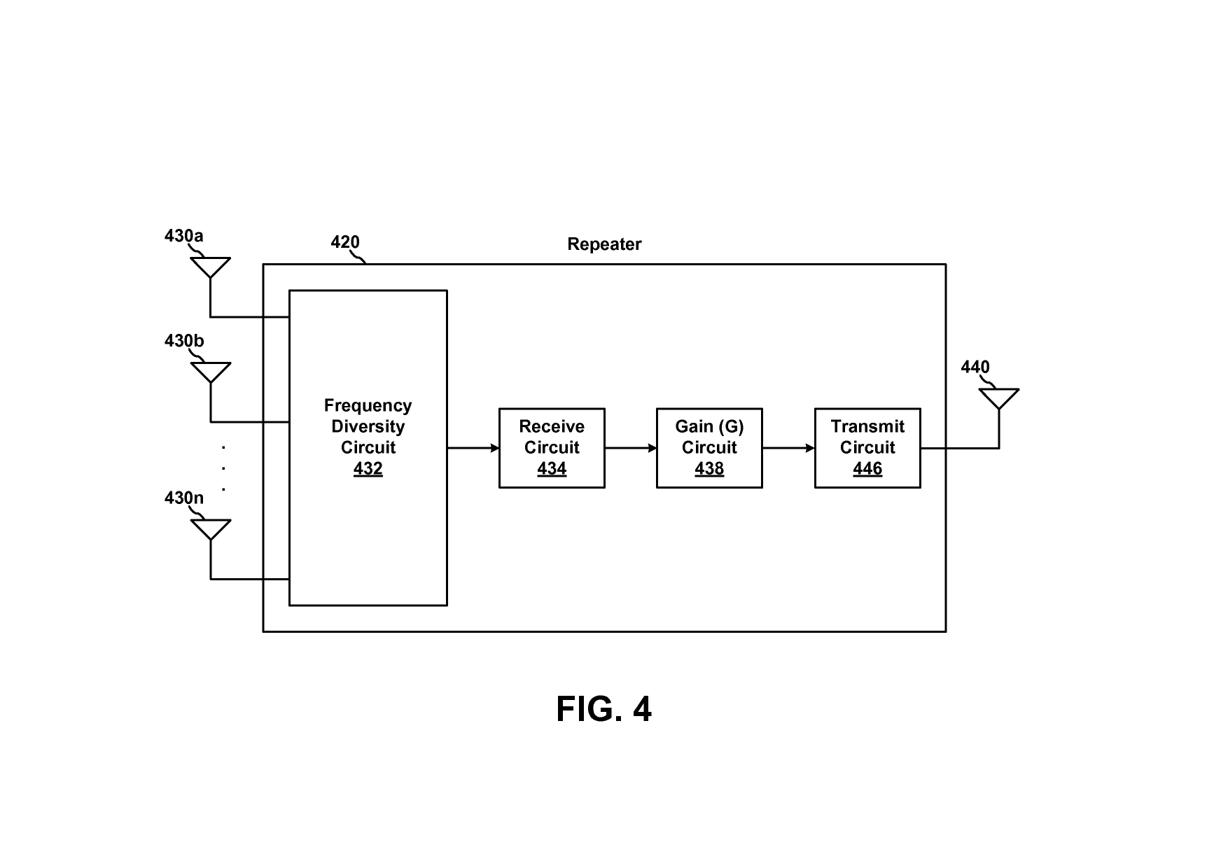

FIG. 4 shows a diagram illustrating a hardware implementation of an apparatus 420 comprising, in an embodiment, a repeater for a wireless communication system, in accordance with aspects of the disclosure. The repeater 420 is configured to receive a signal, amplify the received signal, and transmit the amplified signal. For instance, the repeater 420 may be configured to receive one or more signals on one or more receive antennas 430a, 430b, . . . , 430n (e.g., one or more donor antennas, such as the one or more of donor antennas 215 of FIG. 2A) through a frequency diversity circuit 432 (e.g., 380 of FIG. 3A or 382 of FIG. 3B) and a receive interface circuit 434 configured to provide an interface to an amplifier circuit 438.

In an embodiment, the received signal may comprise a remote signal (e.g., such as remote signal 140) to be repeated and may include a feedback signal (e.g., such as feedback signal 222) resulting from a feedback channel between the receive antenna 430 and a transmit antenna 440 (e.g., such as a server antenna, e.g., the server antenna 220 of FIG. 2A) of the repeater 420. In the repeater 420, at least the remote signal component of the received signal is amplified by the amplifier circuit 438 having a gain of G. The amplifier circuit 438 may be configured to generate an amplified signal to be transmitted from the repeater 420 via a transmitter circuit 446 and the transmit antenna 440. The amplified signal may be delayed by a delay value (A) via a delay circuit prior to being transmitted.

In an embodiment, the repeater 420 may be optionally implemented with or without echo cancellation via an echo cancellation circuit. When the repeater 420 comprises echo cancellation, an echo canceller may be provided before the amplifier circuit 438 to cancel undesirable feedback signals from the received signal. The repeater 420 may comprise other control circuitry, such as a channel estimation block for estimating the feedback channel and a gain control block for controlling the gain of the amplifier circuit 438. These and various other control circuitry of the repeater 420 may not be shown in FIG. 4 to simplify the discussion. However, it should be understood that the repeater 420 may include one or more other elements and/or components to realize full repeater operation.

In the repeater 420, before the amplified signal is transmitted via the transmit antenna 440, a transmit message signal may be added to the amplified signal to enable repeater communication. The amplified signal and the transmit message signal may be combined and provided to the transmit circuit 446 to be transmitted via the transmit antenna 440. The transmit circuit 446 may include one or more filters and/or driver circuitry. The transmit message signal may comprise a low power spreading sequence and may comprise a power level much less than the power level of the amplified signal. The low power transmit message signal may be transmitted by the repeater 420 via the transmit circuit 446 and the transmit antenna 440.

In an implementation, the repeater 420 may comprise a detect circuit configured for detecting power of received signals, detecting changes in power of received signals, and/or adjusting amplification of received signals based on detected changes in power prior to transmitting the signals, for example, by providing a control signal to the amplifier circuit 438. The detect circuit may also be configured for receiving either the echo-cancelled receive signal or the receive signal as an input signal and for processing the input signal to detect and identify any low power message signal that may be provided in the receive signal. The detected message signal, which may be referred to as a receive message signal, may be utilized by the repeater 420 to initiate appropriate or desired mitigation strategies. For instance, when the message signal is a low power spreading sequence, techniques familiar to those skilled in the art may be utilized to ensure detection of the low power spreading sequence embedded in the receive signal. The detect circuit of the repeater 400 may be deployed in a multi-repeater environment with other similarly constructed repeaters for facilitating inter-repeater communication. In some instances, the repeater 420 may transmit a message signal, and it may not be necessary for the repeater 420 to detect the message signal from other repeaters. In this instance, the detect circuit may be considered optional and thus omitted. However, the receiver circuit 434 may be configured to comprise the detect circuit or at least the functionality of the detect circuit.

In an implementation, the message signal may encode identification of the repeater 420, operational characteristics of the repeater 420, and/or various other useful information for use by the repeaters in a multi-repeater environment. In an example, the message signal may comprise a low power spreading sequence for identifying the repeater 420. In other examples, the message signal encodes information relating to the operational characteristics of the repeater 420. For example, the message signal may encode a gain level of the repeater 420, and/or the power level that the repeater 420 receives from other proximate repeaters. The message signal may be configured to encode a value for power amplifier headroom of the repeater 420. In some instances, providing power amplifier headroom information in the message signal provides advantages for communicating with an end-user wireless communication device to enable the end-user wireless communication device to transmit signals to the repeater 420 using the appropriate power level.

Accordingly, in an embodiment, the apparatus for wireless communication may comprise the repeater 420 providing means for receiving signals from a first donor antenna 430a of the repeater 420, means for receiving signals from a second donor antenna 430b of the repeater 420, means for generating delayed signals from the first donor antenna 430a, means for generating a combined signal including the delayed signals from the first antenna input and the signals from the second antenna input, means for interfacing with amplifier circuitry 438 of the repeater 420 for amplifying the combined signal, and means for transmitting the combined signal via the transmitting antenna 440.

In another embodiment, the apparatus for wireless communication may comprise the repeater 420 providing means for receiving a plurality of signals from a plurality of receiving donor antennas 430a, 430b, means for delaying at least one of the received signals from at least one of the receiving donor antennas 430a, means for combining the delayed signal with at least one of the other received signals from at least one other receiving donor antenna 430b to generate a combined signal, means for amplifying the combined signal, and means for transmitting the amplified combined signal via the transmitting antenna 440.

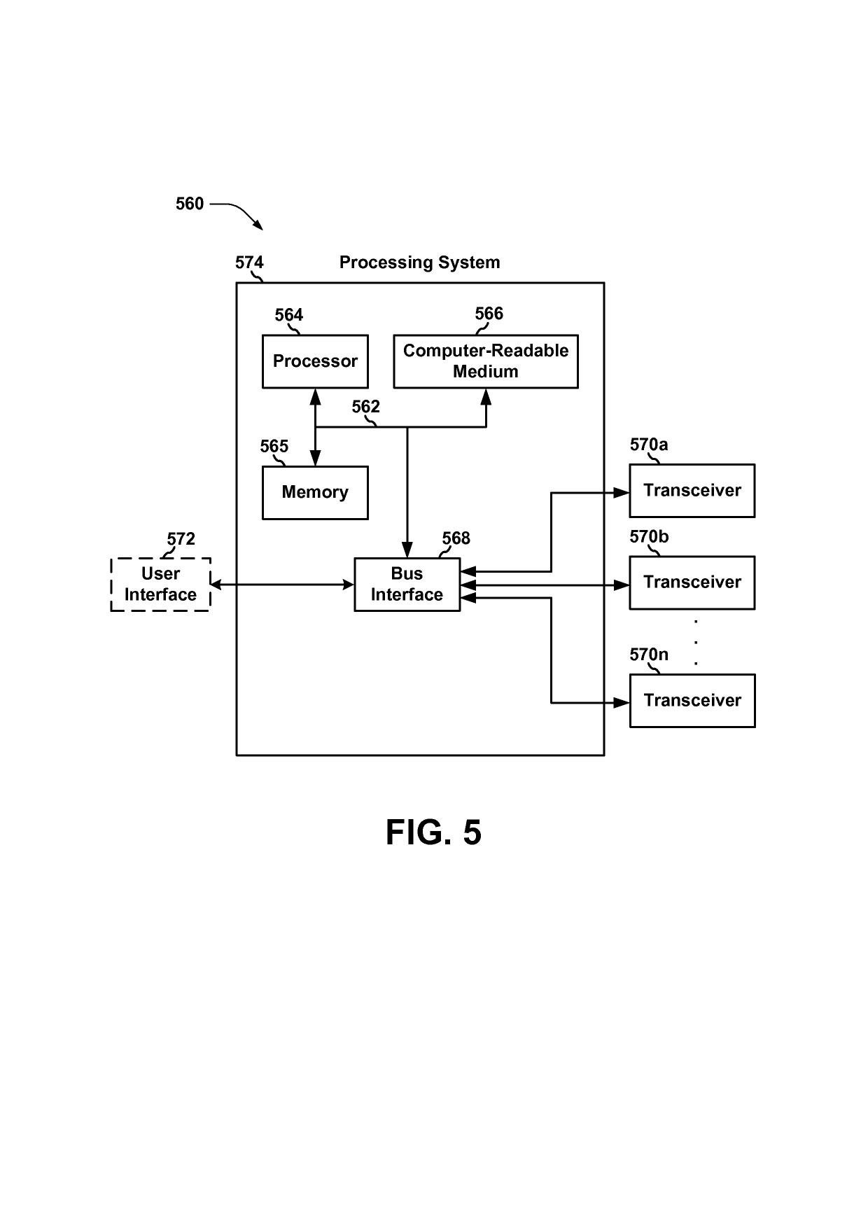

FIG. 5 shows a diagram illustrating an embodiment of a hardware implementation for an apparatus 560 employing a processing system 574 having a memory 565, in accordance with aspects of the disclosure. In an embodiment, the apparatus 560 may be configured to operate as a repeater. The processing system 574 may comprise an analog device, a digital device, or an analog/digital device and may be implemented with a bus architecture, represented generally by a bus 562. The bus 562 may include any number of interconnecting buses and bridges depending on specific application of the processing system 574 and the design constraints. The bus 562 is configured to link together various circuits including one or more processors, represented generally by a processor 564, and computer-readable media, represented generally by a computer-readable medium 566. The bus 562 may link various other circuits, such as, for example, timing sources, peripherals, voltage regulators, and power management circuits, which are known in the art, and therefore, will not be described any further. A bus interface 568 provides an interface between the bus 562 and one or more transceivers 570a, 570b, . . . , 570n, which may be referred to as gain devices. Each of the transceivers 570a, 570b, . . . , 570n provides a means for communicating (including receiving and transmitting signals) with various other apparatus over a transmission medium. In an implementation, depending upon the nature of the apparatus 560, a user interface 572 (e.g., keypad, display, speaker, microphone, joystick) may be optionally provided.

In accordance with aspects of the disclosure, the processor 564 may be configured to manage the bus 562 and general processing, including the execution of software stored on memory 565 and/or on the computer-readable medium 566. The software, when executed by the processor 564, causes the processing system 574 to perform the various functions, processes, and/or algorithms described herein for any particular apparatus. The computer-readable medium 566 may also be utilized to store data that is manipulated by the processor 564 when executing software. The processor 564 may be configured to control the transceivers 570a, 570b, . . . , 570n to provide analog and/or digital processing (including echo cancellation, signal filtering, received power determination, amplified signal transformation, addition of signals, etc.) and provide gain control for received and/or transmitted signals.

In accordance with aspects of the disclosure, the apparatus 560 may be configured to operate as a repeater having frequency diversity functionality, and the processing system 574 may be configured to perform operations relating to the repeater. Accordingly, the apparatus 560 comprising the processing system 574 may be configured to implement aspects of the disclosure as provided herein.

Further referring to FIG. 5, in an embodiment, the apparatus for wireless communication may comprise the repeater 560 comprising the processing system 574 configured to receive signals via the first transceiver 570a (e.g., first donor antenna) of the repeater 574, receive signals via the second transceiver 570a (e.g., second donor antenna) of the repeater 574, generate delayed signals from the first transceiver 570a, generate a combined signal including the delayed signals from the first antenna input and the signals from the second antenna input, interface with amplifier circuitry of the repeater 574 for amplifying the combined signal, and transmitting the combined signal via the first or second transceiver 570a, 570b or another transceiver (e.g., 570n).

In another embodiment, the apparatus for wireless communication depicted in FIG. 5 may comprise the repeater 560 comprising the processing system 574 configured to receive a plurality of signals via the transceivers 570a, 570b of the repeater 574, delay at least one of the received signals from at least one of the transceivers (e.g., transceiver 570a), combine the delayed signal with at least one of the other received signals from at least one other transceivers (e.g., transceiver 570b) to generate a combined signal, amplify the combined signal, and transmit the amplified combined signal via the first or second transceiver 570a, 570b or another transceiver (e.g., 570n).

According to aspects of the disclosure, repeaters may be deployed to resolve wireless coverage limitations. Generally, repeaters receive a weak incoming signal, amplify the received signal, and retransmit the amplified signal to an intended receiver. In a full duplex solution, the reception, amplification, and transmission may occur at the same time, except for processing and internal propagation delays or intentional small time offsets. In some instances, a problem may arise when the signal reception and transmission occurs on the same frequency, since the transmitted signal may also be received at the same time with the desired receive signal, thus creating interference. Although the created interference may be viewed as a replica of the desired signal, which may not necessarily be harmful to the intended receiver, but from the repeater operation's viewpoint, interference may create a positive feedback introducing stability problems.

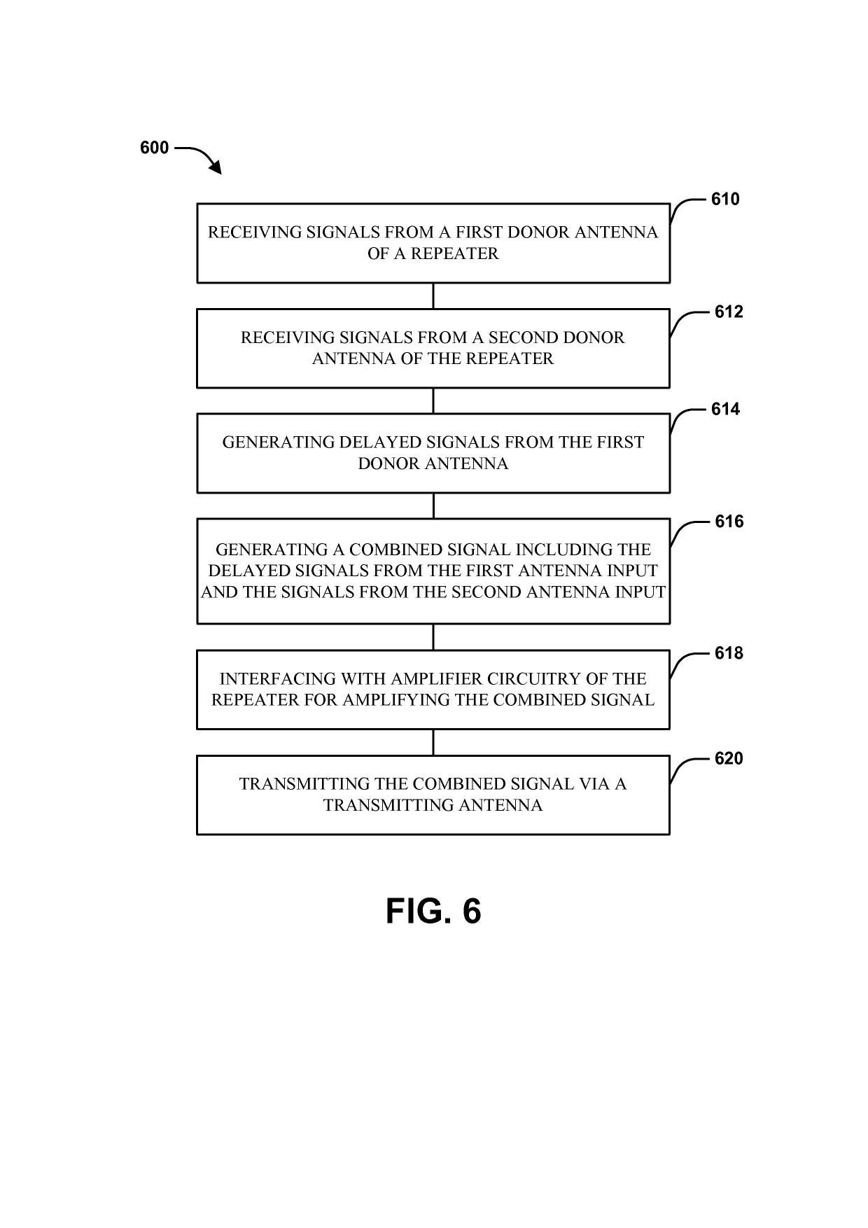

FIG. 6 shows a diagram illustrating a methodology 600 for facilitating wireless communication, in accordance with aspects of the disclosure. In reference to FIG. 6, the method 600 may comprise, at 610, receiving signals from a first donor antenna of a repeater. At 612, the method 600 may comprise receiving signals from a second donor antenna of the repeater. At 614, the method 600 may comprise generating delayed signals from the first donor antenna. At 616, the method 600 may comprise generating a combined signal including the delayed signals from the first antenna input and the signals from the second antenna input. At 618, the method 600 may comprise interfacing with amplifier circuitry of the repeater for amplifying the combined signal. At 620, the method 600 may comprise transmitting the combined signal via a transmitting antenna.

In an implementation, referring to FIG. 6, the method 600 may be configured for wireless communication in a Long Term Evolution (LTE) based network. The method 600 may further comprise utilizing LTE based sampling to delay the signals received from the first antenna input. The method 600 may further comprise generating delayed signals from the second donor antenna, wherein the combined signal may include the delayed signals from the first antenna input and the delayed signals from the second antenna input. In an aspect, generating delayed signals from the second donor antenna may include utilizing LTE based sampling to delay the signals received from the second antenna input.

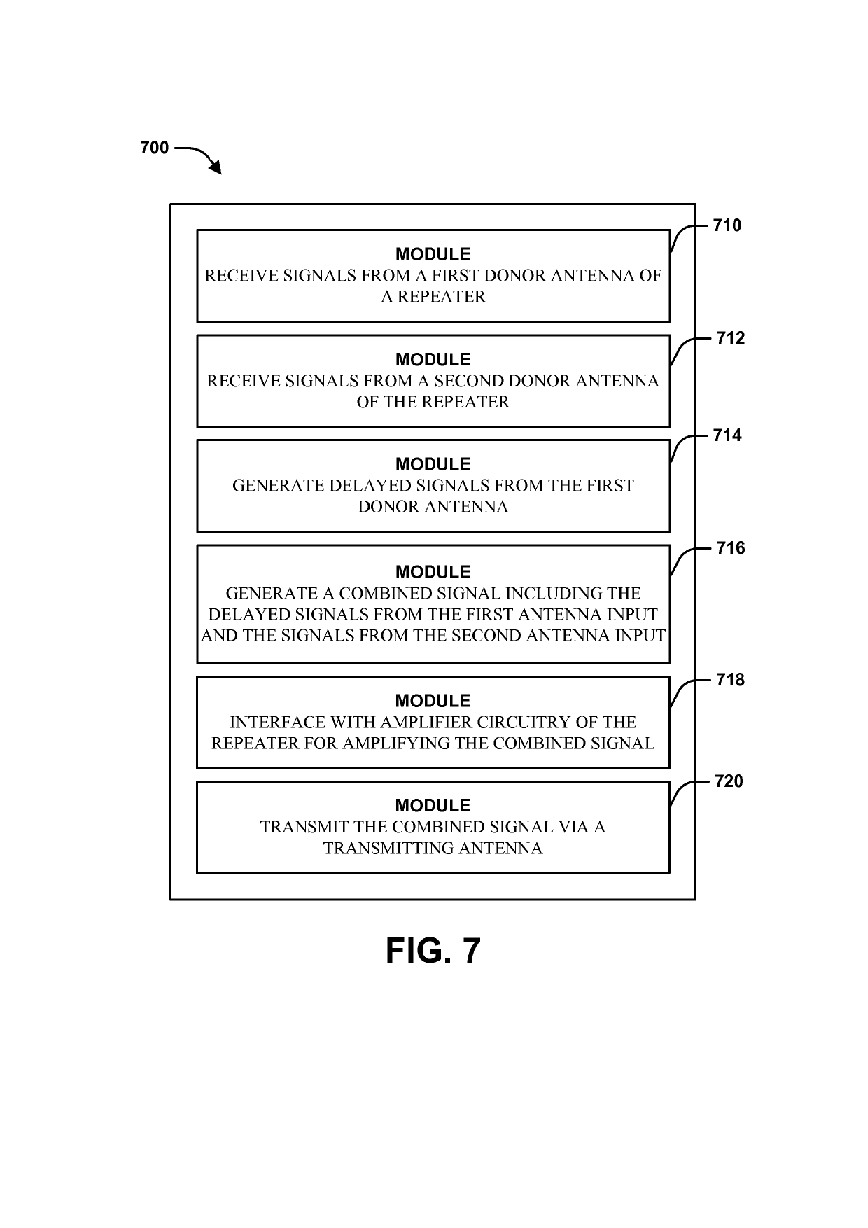

FIG. 7 shows a diagram illustrating the functionality of an apparatus 700 configured to facilitate wireless communication, in accordance with aspects of the disclosure. The apparatus 700 may include a module 710 configured to receive signals from a first donor antenna of a repeater. The apparatus 700 may include a module 712 configured to receive signals from a second donor antenna of the repeater. The apparatus 700 may include a module 714 configured to generate delayed signals from the first donor antenna. The apparatus 700 may include a module 716 configured to generate a combined signal including the delayed signals from the first antenna input and the signals from the second antenna input. The apparatus 700 may include a module 718 configured to interface with amplifier circuitry of the repeater for amplifying the combined signal. The apparatus 700 may include a module 720 configured to transmit the combined signal via a transmitting antenna. In various implementations, the apparatus 700 may include additional modules that perform each of the steps in the aforementioned flow chart. As such, each step in the aforementioned flow chart may be performed by a module, and the apparatus 700 may include one or more of those modules.

In an implementation, referring to FIG. 7, the apparatus 700 may be configured for wireless communication in an LTE based network. The apparatus 700 may further comprise a module configured to utilize LTE based sampling to delay the signals received from the first antenna input. The apparatus 700 may further comprise a module configured to generate delayed signals from the second donor antenna, wherein the combined signal may include the delayed signals from the first antenna input and the delayed signals from the second antenna input. In an aspect, the module configured to generate delayed signals from the second donor antenna may be further configured to utilize LTE based sampling to delay the signals received from the second antenna input.

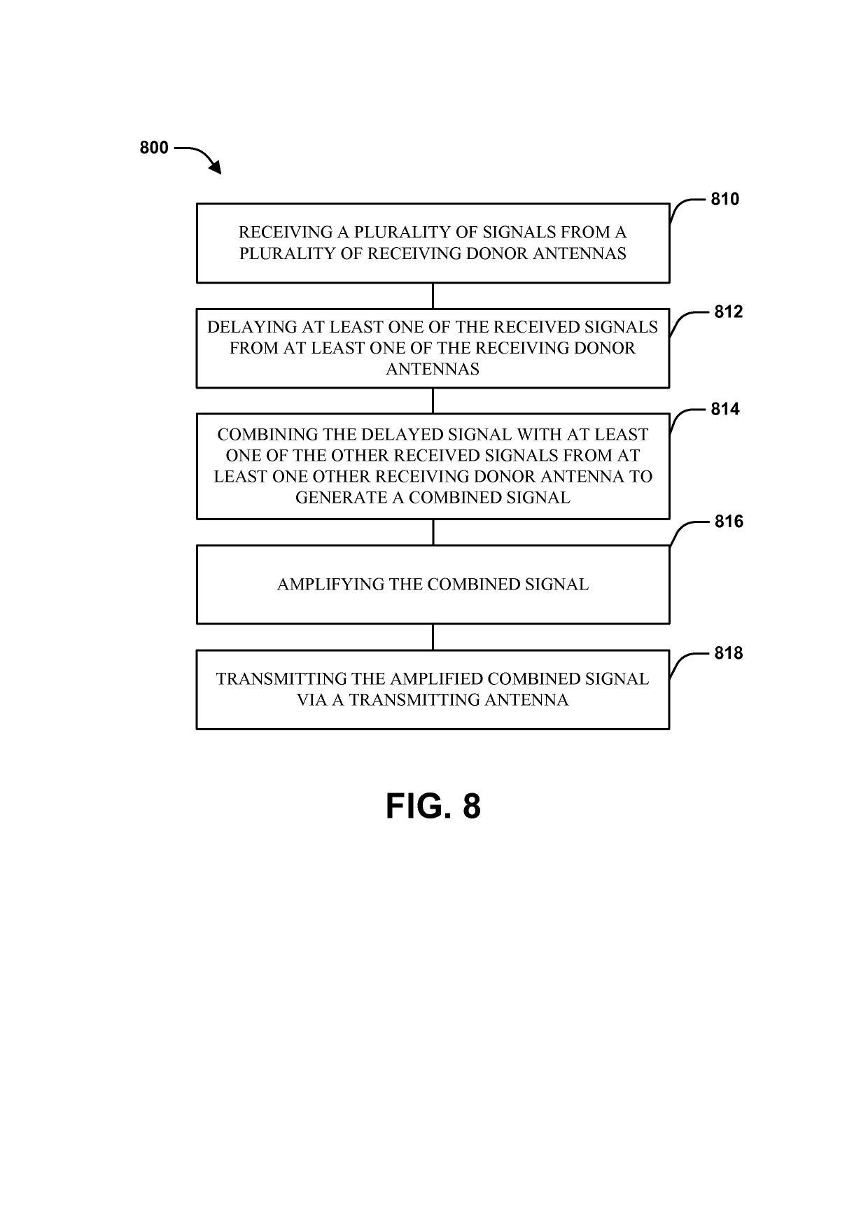

FIG. 8 shows a diagram illustrating a methodology 800 for facilitating wireless communication, in accordance with aspects of the disclosure. In reference to FIG. 8, the method 800 may comprise, at 810, receiving a plurality of signals from a plurality of receiving donor antennas. At 812, the method may comprise delaying at least one of the received signals from at least one of the receiving donor antennas. At 814, the method may comprise combining the delayed signal with at least one of the other received signals from at least one other receiving donor antenna to generate a combined signal. At 816, the method may comprise amplifying the combined signal. At 818, the method may comprise transmitting the amplified combined signal via a transmitting antenna.

In an implementation, referring to FIG. 8, the method 800 may be configured for wireless communication in an LTE based network. In an aspect, the delaying may comprise delaying at least one of the received signals from at least one of the receiving donor antennas by one or more samples to generate the delayed signal, wherein the delaying may comprise utilizing LTE based sampling to delay at least one of the received signals from at least one of the receiving donor antennas and generate the delayed signal. In another aspect, the combining may comprise adding the delayed signal to at least one of the other received signals from at least one other receiving donor antenna to generate the combined signal. In another aspect, the delaying at least one of the received signals from at least one of the receiving donor antennas may comprise separately delaying each of the received signals from each the receiving donor antennas with a sampling delay difference, and the combining may comprise combining the delayed signals to generate a combined signal. In another aspect, amplifying the combined signal may be achieved with an amplifier circuit of a repeater.

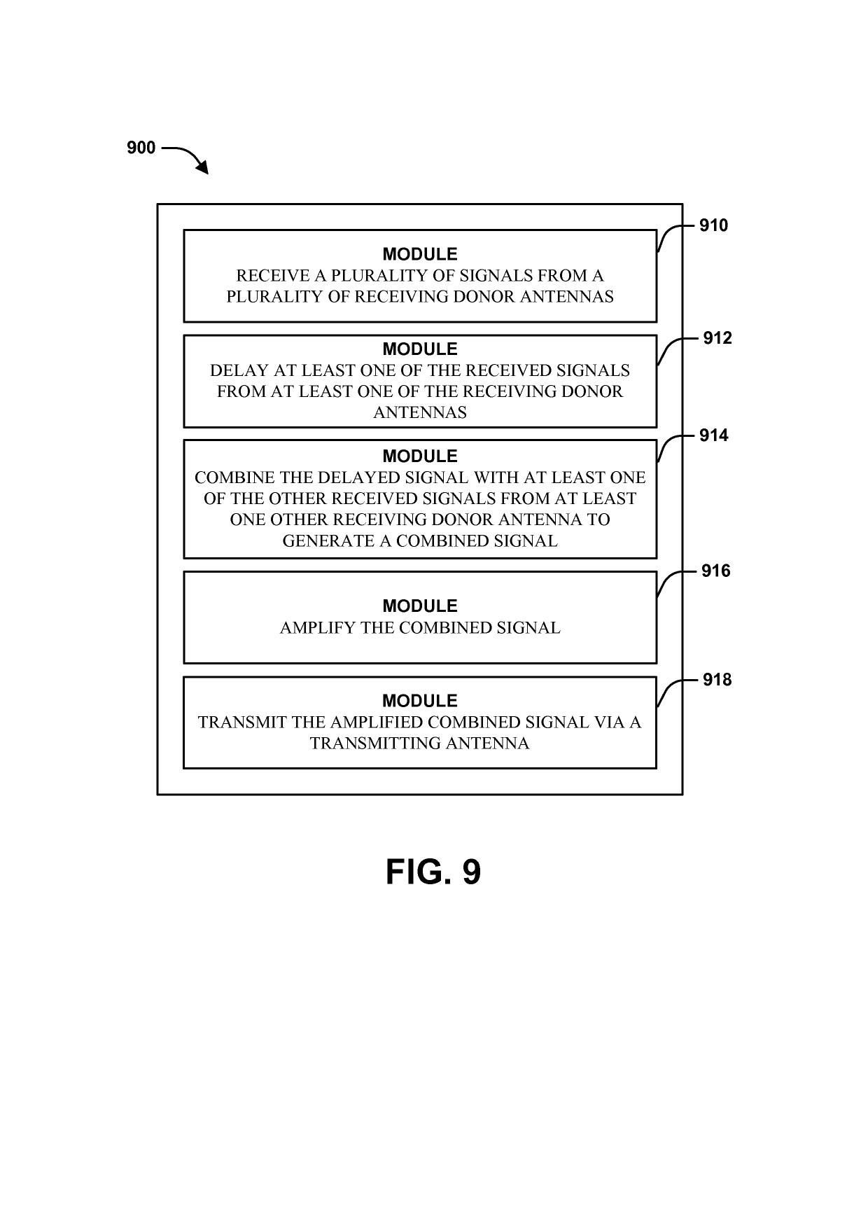

FIG. 9 shows a diagram illustrating the functionality of an apparatus 900 configured to facilitate wireless communication, in accordance with aspects of the disclosure. The apparatus 900 may include a module 910 configured to receive a plurality of signals from a plurality of receiving donor antennas. The apparatus 900 may include a module 912 configured to delay at least one of the received signals from at least one of the receiving donor antennas. The apparatus 900 may include a module 914 configured to combine the delayed signal with at least one of the other received signals from at least one other receiving donor antenna to generate a combined signal. The apparatus 900 may include a module 916 configured to amplify the combined signal. The apparatus 900 may include a module 918 configured to transmit the amplified combined signal via a transmitting antenna. In various implementations, the apparatus 900 may include additional modules that perform each of the steps in the aforementioned flow chart. As such, each step in the aforementioned flow chart may be performed by a module, and the apparatus 900 may include one or more of those modules.

In an implementation, referring to FIG. 9, the apparatus 900 may be configured for wireless communication in an LTE based network. In an aspect, the module configured to delay may be configured to delay at least one of the received signals from at least one of the receiving donor antennas by one or more samples to generate the delayed signal, wherein the delaying may comprise utilizing LTE based sampling to delay at least one of the received signals from at least one of the receiving donor antennas and generate the delayed signal. In another aspect, the module configured to combine may be configured to add the delayed signal to at least one of the other received signals from at least one other receiving donor antenna to generate the combined signal. In another aspect, the module configured to delay at least one of the received signals from at least one of the receiving donor antennas may be configured to separately delay each of the received signals from each of the receiving donor antennas with a sampling delay difference, and the module configured to combine may be configured to combine the delayed signals to generate a combined signal. In another aspect, amplifying the combined signal may be achieved with an amplifier circuit of a repeater.

It will be appreciated that, in accordance with one or more aspects described herein, inferences may be made regarding or for performing the functions described herein. As utilized herein, the term to “infer” or “inference” refers generally to the process of reasoning about or inferring states of the system, environment, and/or user from a set of observations as captured via events and/or data. Inference may be employed to identify a specific context or action, or may generate a probability distribution over states, for example. The inference may be probabilistic—that is, the computation of a probability distribution over states of interest based on a consideration of data and events. Inference may also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

It is understood that the specific order or hierarchy of steps in the processes disclosed is an example of exemplary approaches. Based upon design preferences, it is understood that the specific order or hierarchy of steps in the processes may be rearranged while remaining within the scope of the disclosure. The accompanying method claims present elements of the various steps in a sample order, and are not meant to be limited to the specific order or hierarchy presented.

Those of skill in the art would understand that information and signals may be represented utilizing any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor may read information from, and write information to, the storage medium. In the alternative, the storage medium may be integral to the processor. The processor and the storage medium may reside in an ASIC. The ASIC may reside in a UE. In the alternative, the processor and the storage medium may reside as discrete components in a UE.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited utilizing the phrase “means for” or, in the case of a method claim, the element is recited utilizing the phrase “step for.”

What is claimed is:

1. An antenna-repeater interface apparatus comprising:
a first antenna input configured to receive signals from a first donor antenna of a repeater;
a second antenna input configured to receive signals from a second donor antenna of the repeater;
an adaptable delay in communication with the first antenna input, the adaptable delay configured to generate delayed signals from the first donor antenna;
a combiner configured to generate a combined signal including the delayed signals from the first antenna input and the signals from the second antenna input; and
an interface configured to provide an interface to amplifier circuitry of the repeater for amplifying the combined signal.

2. The apparatus of claim 1, wherein the adaptable delay utilizes Long Term Evolution (LTE) based sampling to delay the signals received from the first antenna input.

3. The apparatus of claim 1, wherein the combiner comprises an adder configured to add the delayed signals from the first antenna input to the signals from the second antenna input to generate the combined signal.

4. The apparatus of claim 1, wherein the interface comprises a single receive chain interposed between the combiner and the amplifier circuitry.

5. The apparatus of claim 1, further comprising a transmitting interface configured to interface with the amplifier circuitry to receive the combined signal and transmit the combined signal via a transmitting antenna.

6. The apparatus of claim 5, wherein the transmitting interface comprises a single transmit chain interposed between the amplifier circuitry and the transmitting antenna.

7. The apparatus of claim 1, further comprising a delay in communication with the second antenna input, wherein the delay is configured to generate delayed signals from the second donor antenna.

8. The apparatus of claim 7, wherein the combiner is configured to generate a combined signal including the delayed signals from the first antenna input and the delayed signals from the second antenna input.

9. The apparatus of claim 7, wherein the delay utilizes Long Term Evolution (LTE) based sampling to delay the signals received from the second antenna input.

10. The apparatus of claim 1, wherein the apparatus is configured for wireless communication in a Long Term Evolution (LTE) based network.

11. A method for wireless communication, comprising:
receiving signals from a first donor antenna of a repeater;
receiving signals from a second donor antenna of the repeater;
generating delayed signals from the first donor antenna;
generating a combined signal including the delayed signals from the first antenna input and the signals from the second antenna input; and
interfacing with amplifier circuitry of the repeater for amplifying the combined signal.

12. The method of claim 11, further comprising utilizing Long Term Evolution (LTE) based sampling to delay the signals received from the first antenna input.

13. The method of claim 11, further comprising transmitting the combined signal via a transmitting antenna.

14. The method of claim 11, further comprising generating delayed signals from the second donor antenna.

15. The method of claim 14, wherein the combined signal includes the delayed signals from the first antenna input and the delayed signals from the second antenna input.

16. The method of claim 14, wherein generating delayed signals from the second donor antenna includes utilizing Long Term Evolution (LTE) based sampling to delay the signals received from the second antenna input.

17. The method of claim 11, wherein the method is configured for wireless communication in a Long Term Evolution (LTE) based network.

18. An apparatus for wireless communication, comprising:
means for receiving signals from a first donor antenna of a repeater;
means for receiving signals from a second donor antenna of the repeater;
means for generating delayed signals from the first donor antenna;
means for generating a combined signal including the delayed signals from the first antenna input and the signals from the second antenna input; and
means for interfacing with amplifier circuitry of the repeater for amplifying the combined signal.

19. The apparatus of claim 18, further comprising means for utilizing Long Term Evolution (LTE) based sampling to delay the signals received from the first antenna input.

20. The apparatus of claim 18, further comprising means for transmitting the combined signal via a transmitting antenna.

21. The apparatus of claim 18, further comprising means for generating delayed signals from the second donor antenna.

22. The apparatus of claim 21, wherein the combined signal includes the delayed signals from the first antenna input and the delayed signals from the second antenna input.

23. The apparatus of claim 21, wherein the means for generating delayed signals from the second donor antenna includes means for utilizing Long Term Evolution (LTE) based sampling to delay the signals received from the second antenna input.

24. The apparatus of claim 18, wherein the apparatus is configured for wireless communication in a Long Term Evolution (LTE) based network.

25. A computer program product, comprising:
a computer-readable medium comprising codes executable to cause an apparatus to:
receive signals from a first donor antenna of a repeater;
receive signals from a second donor antenna of the repeater;
generate delayed signals from the first donor antenna;
generate a combined signal including the delayed signals from the first antenna input and the signals from the second antenna input; and
interface with amplifier circuitry of the repeater for amplifying the combined signal.

26. The computer program product of claim 25, further comprising codes executable to cause the apparatus to utilize Long Term Evolution (LTE) based sampling to delay the signals received from the first antenna input.

27. The computer program product of claim 25, further comprising codes executable to cause the apparatus to transmit the combined signal via a transmitting antenna.

28. The computer program product of claim 25, further comprising codes executable to cause the apparatus to generate delayed signals from the second donor antenna.

29. The computer program product of claim 28, wherein the combined signal includes the delayed signals from the first antenna input and the delayed signals from the second antenna input.

30. The computer program product of claim 28, wherein the codes executable to cause the apparatus to generate delayed signals from the second donor antenna includes codes executable to cause the apparatus to utilize Long Term Evolution (LTE) based sampling to delay the signals received from the second antenna input.

31. A repeater apparatus for wireless communication, comprising:
a frequency diversity circuit configured to receive a plurality of signals from a plurality of receiving donor antennas, delay at least one of the received signals from at least one of the receiving donor antennas, and combine the delayed signal with at least one of the other received signals from at least one other receiving donor antenna to generate a combined signal; and
an amplifier circuit configured to receive the combined signal from the frequency diversity circuit, amplify the combined signal, and transmit the amplified combined signal via a transmitting antenna.

32. The apparatus of claim 31, wherein the frequency diversity circuit comprises an adaptable delay configured to delay the at least one of the received signals from the at least one of the receiving donor antennas by one or more samples to generate the delayed signal.

33. The apparatus of claim 32, wherein the adaptable delay utilizes Long Term Evolution (LTE) based sampling to delay the at least one of the received signals from the at least one of the receiving donor antennas and generate the delayed signal.

34. The apparatus of claim 31, wherein the frequency diversity circuit comprises a combiner circuit configured to combine the delayed signal to the at least one of the other received signals from the at least one other receiving donor antenna to generate the combined signal.

35. The apparatus of claim 34, wherein the combiner circuit comprises an adder configured to add the delayed signal to the at least one of the other received signals from the at least one other receiving donor antenna to generate the combined signal.

36. The apparatus of claim 31, further comprising a receiving interface having a single receive chain interposed between the frequency diversity circuit and the amplifier circuit.

37. The apparatus of claim 31, wherein the transmitting antenna is configured to receive the combined signal from the amplifier circuit and transmit the combined signal.

38. The apparatus of claim 31, further comprising a transmitting interface having a single transmit chain interposed between the amplifier circuit and the transmitting antenna.

39. The apparatus of claim 31, wherein the frequency diversity circuit is configured to separately delay each of the received signals from each the receiving donor antennas with a sampling delay difference and combine the delayed signals to generate a combined signal.

40. The apparatus of claim 31, wherein the amplifier circuit comprises repeater circuitry.

41. The apparatus of claim 31, wherein the apparatus is configured for wireless communication in a Long Term Evolution (LTE) based network.

42. A method for wireless communication, comprising:
receiving a plurality of signals from a plurality of receiving donor antennas;
delaying at least one of the received signals from at least one of the receiving donor antennas;
combining the delayed signal with at least one of the other received signals from at least one other receiving donor antenna to generate a combined signal;
amplifying the combined signal; and
transmitting the amplified combined signal via a transmitting antenna.

43. The method of claim 42, wherein the delaying comprises delaying the at least one of the received signals from the at least one of the receiving donor antennas by one or more samples to generate the delayed signal.

44. The method of claim 43, wherein the delaying comprises utilizing Long Term Evolution (LTE) based sampling to delay the at least one of the received signals from the at least one of the receiving donor antennas and generate the delayed signal.

45. The method of claim 42, wherein the combining comprises adding the delayed signal to the at least one of the other received signals from the at least one other receiving donor antenna to generate the combined signal.

46. The method of claim 42, wherein:
the delaying at least one of the received signals from at least one of the receiving donor antennas comprises separately delaying each of the received signals from each the receiving donor antennas with a sampling delay difference, and
the combining comprises combining the delayed signals to generate a combined signal.

47. The method of claim 42, wherein the amplifying the combined signal is achieved with an amplifier circuit of a repeater.

48. The method of claim 42, wherein the method is configured for wireless communication in a Long Term Evolution (LTE) based network.

49. An apparatus for wireless communication, comprising:
means for receiving a plurality of signals from a plurality of receiving donor antennas;
means for delaying at least one of the received signals from at least one of the receiving donor antennas;
means for combining the delayed signal with at least one of the other received signals from at least one other receiving donor antenna to generate a combined signal;
means for amplifying the combined signal; and
means for transmitting the amplified combined signal via a transmitting antenna.

50. The apparatus of claim 49, wherein the delaying comprises delaying the at least one of the received signals from the at least one of the receiving donor antennas by one or more samples to generate the delayed signal.

51. The apparatus of claim 50, wherein the means for delaying comprises means for utilizing Long Term Evolution (LTE) based sampling to delay the at least one of the received signals from the at least one of the receiving donor antennas and generate the delayed signal.

52. The apparatus of claim 49, wherein the means for combining comprises means for adding the delayed signal to the at least one of the other received signals from the at least one other receiving donor antenna to generate the combined signal.

53. The apparatus of claim 49, wherein:
the means for delaying at least one of the received signals from at least one of the receiving donor antennas comprises means for separately delaying each of the received signals from each the receiving donor antennas with a sampling delay difference, and
the means for combining comprises means for combining the delayed signals to generate a combined signal.

54. The apparatus of claim 49, wherein the means for amplifying the combined signal is achieved with an amplifier circuit of a repeater.

55. The apparatus of claim 49, wherein the apparatus is configured for wireless communication in a Long Term Evolution (LTE) based network.

56. A computer program product, comprising:
a computer-readable medium comprising codes executable to cause an apparatus to:
receive a plurality of signals from a plurality of receiving donor antennas;
delay at least one of the received signals from at least one of the receiving donor antennas;
combine the delayed signal with at least one of the other received signals from at least one other receiving donor antenna to generate a combined signal;
amplify the combined signal; and
transmit the amplified combined signal via a transmitting antenna.

57. The computer program product of claim 56, wherein the code for delaying comprises code for delaying the at least one of the received signals from the at least one of the receiving donor antennas by one or more samples to generate the delayed signal.

58. The computer program product of claim 57, wherein the code for delaying comprises code for utilizing Long Term Evolution (LTE) based sampling to delay the at least one of the received signals from the at least one of the receiving donor antennas and generate the delayed signal.

59. The computer program product of claim 56, wherein the code for combining comprises code for adding the delayed signal to the at least one of the other received signals from the at least one other receiving donor antenna to generate the combined signal.

60. The computer program product of claim 56, wherein:
the code for delaying at least one of the received signals from at least one of the receiving donor antennas comprises code for separately delaying each of the received signals from each the receiving donor antennas with a sampling delay difference, and
the code for combining comprises code for combining the delayed signals to generate a combined signal.
